(19) United States
(12) Patent Application Publication
(10) Pub. No.: US 2023/0113168 A1
(43) Pub. Date: Apr. 13, 2023

(54) DECENTRALIZED POLICY GRADIENT DESCENT AND ASCENT FOR SAFE MULTI-AGENT REINFORCEMENT LEARNING

(71) Applicants: International Business Machines Corporation, Armonk, NY (US); RENSSELAER POLYTECHNIC INSTITUTE, Tory, NY (US)

(72) Inventors: Songtao Lu, White Plains, NY (US); Lior Horesh, North Salem, NY (US); Pin-Yu Chen, White Plains, NY (US); Sijia Liu, Somerville, MA (US); Tianyi Chen, Rensselaer, NY (US)

(21) Appl. No.: 17/499,815

(22) Filed: Oct. 12, 2021

(51) Int. Cl. G06N 20/00; G05B 13/04; B60W 50/00

(52) U.S. Cl. CPC G06N 20/00; G05B 13/042; B60W 50/00; G06Q 10/06313

(57) ABSTRACT

A reinforcement learning system includes a plurality of agents, each agent having an individual reward function and one or more safety constraints that involve joint actions of the agents, wherein each agent maximizes a team-average long-term return in performing the joint actions, subject to the safety constraints, and participates in operating a physical system. A peer-to-peer communication network is configured to connect the plurality of agents. A distributed constrained Markov decision process (D-CMDP) model is implemented over the peer-to-peer communication network and is configured to perform policy optimization using a decentralized policy gradient (PG) method, wherein the participation of each agent in operating the physical system is based on the D-CMDP model.

### STATEMENT REGARDING PRIOR DISCLOSURES BY THE INVENTOR OR A JOINT INVENTOR

The following disclosure(s) are submitted under 35 U.S.C. 102(b)(1)(A):

Songtao Lu, Kaiqing Zhang, Tianyi Chen, Tamer Basar, and Lior Horesh, Decentralized Policy Gradient Descent Ascent for Safe Multi-Agent Reinforcement Learning, In Proceedings of the AAAI Conference on Artificial Intelligence 2021 May 18 (Vol. 35, No. 10, pp. 8767-8775).

### BACKGROUND

The present invention relates to the electrical, electronic and computer arts, and more specifically, to reinforcement learning systems.

As learning tasks become more sophisticated, the reformulated optimization problems include multiple constraints. Examples of such constraints include being under some budget, or conforming to some prior knowledge about the model. These constraints may not be linear or cannot be satisfied by applying a closed-form projection operation. The considered constraints are typically very general and are typically functions of the model parameters. Another issue regards the scalability of training machine learning models over a network under these constraints. With the growth of the “Internet of Things,” sensors, smart devices, and the like collect data over a network. Performing decentralized learning/training over networks is very challenging.

Reinforcement learning (RL) has achieved success in many sequential decision-making problems, such as operations research, optimal control, bounded rationality, machine learning, and the like. In RL, an agent explores the interactions with an environment so that it is able to maximize a cumulative reward through this learning process. Beyond applying the classical RL techniques in control systems, physical constraints or safety considerations are key components of determining the performance of an RL system. This is especially important in multi-agent RL (MAR-L) that models the sequential decision-making of multiple agents in a shared environment, while each agent's objective, and the system evolution, are both affected by the decisions made by all agents.

### SUMMARY

Principles of the invention provide techniques for reinforcement learning (RL) systems. In one aspect, an exemplary method includes the operations of generating a distributed constrained Markov decision process (D-CMDP) model configured to perform policy optimization using a decentralized policy gradient (PG) method; maximizing a team-average long-term return in performing one or more joint actions, subject to one or more safety constraints, based on an individual reward function; and participating in operating a physical system based on the D-CMDP model.

In one aspect, a reinforcement learning system includes a plurality of agents, each agent having an individual reward function and one or more safety constraints that involve joint actions of the agents, wherein each agent maximizes a team-average long-term return in performing the joint actions, subject to the safety constraints, and participates in operating a physical system; a peer-to-peer communication network configured to connect the plurality of agents; and a distributed constrained Markov decision process (D-CMDP) model implemented over the peer-to-peer communication network and configured to perform policy optimization using a decentralized policy gradient (PG) method, wherein the participation of each agent in operating the physical system is based on the D-CMDP model.

In one aspect, a computer program product for federated learning comprises a computer readable storage medium having program instructions embodied therewith, the program instructions executable by a computer to cause the computer to perform a method comprising generating a distributed constrained Markov decision process (D-CMDP) model configured to perform policy optimization using a decentralized policy gradient (PG) method; maximizing a team-average long-term return in performing one or more joint actions, subject to one or more safety constraints, based on an individual reward function; and participating in operating a physical system based on the D-CMDP model.

As used herein, “facilitating” an action includes performing the action, making the action easier, helping to carry the action out, or causing the action to be performed. Thus, by way of example and not limitation, instructions executing on one processor might facilitate an action carried out by instructions executing on a remote processor, by sending appropriate data or commands to cause or aid the action to be performed. For the avoidance of doubt, where an actor facilitates an action by other than performing the action, the action is nevertheless performed by some entity or combination of entities.

One or more embodiments of the invention or elements thereof can be implemented in the form of a computer program product including a computer readable storage medium with computer usable program code for performing the method steps indicated. Furthermore, one or more embodiments of the invention or elements thereof can be implemented in the form of a system (or apparatus) including a memory, and at least one processor that is coupled to the memory and operative to perform exemplary method steps. Yet further, in another aspect, one or more embodiments of the invention or elements thereof can be implemented in the form of means for carrying out one or more of the method steps described herein; the means can include (i) hardware module(s), (ii) software module(s) stored in a computer readable storage medium (or multiple such media) and implemented on a hardware processor, or (iii) a combination of (i) and (ii); any of (i)-(iii) implement the specific techniques set forth herein.

Techniques of the present invention can provide substantial beneficial technical effects. For example, one or more embodiments provide one or more of:

a decentralized policy gradient (PG) algorithm that accounts for the coupled safety constraints with a quantifiable convergence rate in multi-agent reinforcement learning (MARL);

an algorithm that solves a class of decentralized stochastic nonconvex-concave minimax optimization problems, where both the algorithm design and corresponding theoretical analysis are of independent interest;

a structure for implementing the algorithm in a single-loop, where the parameters that need to be tuned are only the step sizes in the minimization and maximization subproblems;

theoretical guarantees that a decentralized policy gradient (PG) method, referred to herein as Safe Dec-PG, is able to find an ϵ-first-order stationary point (FOSP) of a formulated non-convex min-max problem within

$$O ( \frac{1}{{ϵ}^{4}} )$$

number of iterations, matching the standard convergence rate of centralized stochastic gradient descent (SGD) and decentralized SGD to ϵ-FOSPs in non-convex scenarios;

a general optimization problem solver, which can be applied for dealing with many non-convex min-max problems rather than the RL/MARL problems, and can be implemented in either a decentralized way over a network or on a single machine;

fully decentralized machine learning exhibiting performance comparable to centralized machine learning; and

linear time performance increase resulting from the increase in computational resources provided by the plurality of agents utilized in the disclosed decentralized architecture (but as noted just above with performance comparable to centralized machine learning).

These and other features and advantages of the present invention will become apparent from the following detailed description of illustrative embodiments thereof, which is to be read in connection with the accompanying drawings.

### BRIEF DESCRIPTION OF THE DRAWINGS

FIG. 1A is a block diagram of an example Markov decision process, in accordance with an example embodiment;

FIG. 1B is a block diagram of an example decentralized policy gradient (PG) system, in accordance with an example embodiment;

FIG. 1C is an example algorithm for the decentralized policy gradient (PG), Safe Dec-PG, in accordance with an example embodiment;

FIG. 2A is a table illustrating a detailed comparison between Safe Dec-PG and existing stochastic non-convex concave min-max algorithms in the centralized setting, in accordance with an example embodiment;

FIG. 2B is a graphical representation of a decentralized safe RL system, in accordance with an example embodiment;

FIG. 2C illustrates the long-term cumulative reward of the constraints vs. the number of iterations, in accordance with an example embodiment;

FIG. 2D illustrates the long-term cumulative reward of the objective functions vs. the number of iterations, in accordance with an example embodiment; and

FIG. 3 depicts a cloud computing environment according to an embodiment of the present invention;

FIG. 4 depicts abstraction model layers according to an embodiment of the present invention; and

FIG. 5 depicts a computer system that may be useful in implementing one or more aspects and/or elements of the invention, also representative of a cloud computing node according to an embodiment of the present invention.

### DETAILED DESCRIPTION

Generally, systems and methods for reinforcement learning are disclosed, including distributed reinforcement learning problems with safety constraints. In particular, a team of agents that cooperate in a shared environment is considered, where each agent has its individual reward function and safety constraints that involve all agents' joint actions. As such, the agents aim to maximize the team-average long-term return, subject to all the safety constraints. In one or more embodiments, no central controller is needed to coordinate the agents, and both the rewards and constraints are only known to each agent locally/privately. Instead, the agents are connected by a peer-to-peer communication network to share information with their neighbors. This problem is formulated as a distributed constrained Markov decision process (D-CMDP) with networked agents.

In one example embodiment, a decentralized gradient descent ascent (DGDA) method is used for solving constrained training and learning problems over a network. By leveraging nonlinear programming techniques, the problem is viewed from a game perspective and game stationary points are found by performing gradient descent and ascent in an alternative way and integrating the gradient tracking technique to enforce the consensus constraint. Theoretically, it is proved that, under some mild conditions, the disclosed DGDA method can converge to the epsilon-game stationary point at a rate of 1/epsilon⁴. Numerical results based on solving multi-agent safe reinforcement learning problems show that DGDA can achieve the desired solutions.

In one example embodiment, the Lagrangian framework is used to formulate the constrained optimization problem as a min-max saddle-point problem, where there are two processes of optimization involved: minimization and maximization. The minimization step deals with optimizing the loss function while the maximization step enforces the constraints. The two subroutines are performed in an alternative way. Since the data is collected in a decentralized manner over a network, a communication network is configured such that each node on the network is able to exchange messages with its neighbors. By leveraging the gradient tacking technique, the exemplary embodiment is able to approximate the global information of the whole network and perform the optimization. The three components constitute the main framework of disclosed decentralized gradient descent and ascent methods.

In one example embodiment only three steps are needed: 1) perform local update and aggregation of neighbors' learning variable; 2) estimate the local gradient and implement gradient tracking update; and 3) update local dual variable at each node.

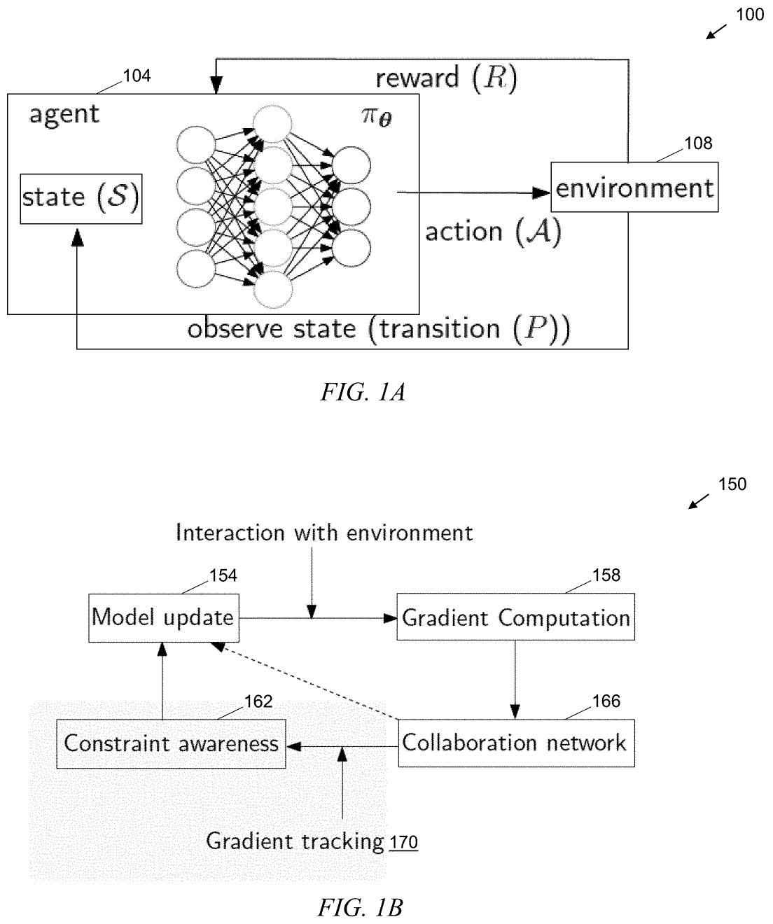

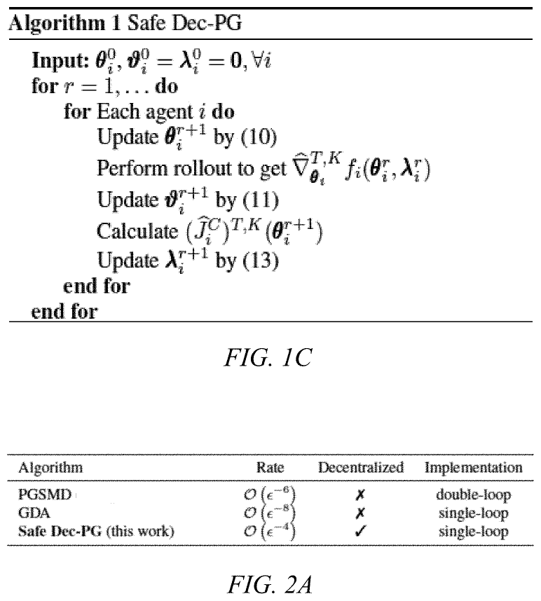

FIG. 1A is a block diagram of an example Markov decision process 100, in accordance with an example embodiment. A number of agents 104 observe a state (transition (P)) of an environment 108 and maintain a local state (S). Based on the current state (S) and the observed state (transition (P)), an action (A) is triggered or performed by the agent 104 in accordance with a state transition function. In addition, a reward (R) is awarded to the agent 104 based on the results of the actions (A) decided by the agent 304 in accordance with an objective function.

FIG. 1B is a block diagram of an example decentralized policy gradient (PG) system 150, in accordance with an example embodiment. Each agent 104 of a plurality of agents 104 resides on a computing node 10 of a collaboration network 166 (also referred to as peer-to-peer communication network 166 herein) and interacts with the environment 108 as well as its neighboring agents 104. (The skilled artisan will be familiar with implementing various peer-to-peer communication networks, including optical-based networks, wired networks, wireless networks, or any combination thereof) In this decentralized architecture, the collaboration network 166 provides communication between the agents 104 to share information (parameters) with neighboring agents 104. Each agent 104 conducts an update via a model update unit 154 based on constraints provided by a constraint awareness unit 162. A gradient computation is performed locally via a gradient computation unit 158 based on a current local model and information from the environment 108, and the gradient computation is shared via the collaboration network 166 with other agents 104 as global gradient tracking 170 (which approximates global gradient information aimed at optimizing the team reward). In one example embodiment, the model update unit 154, the constraint awareness unit 162, and the gradient computation unit 158 reside on the computing node 10. In one example embodiment, a decentralized policy gradient (PG) method, referred to herein as Safe Dec-PG, is utilized to perform policy optimization based on this D-CMDP model over a network. Convergence guarantees, together with numerical results, showcase the superiority of the disclosed algorithm. The decentralized PG algorithm accounts for the coupled safety constraints with a quantifiable convergence rate in multi-agent reinforcement learning. The algorithm solves a class of decentralized stochastic nonconvex-concave minimax optimization problems, where both the algorithm design and corresponding theoretical analysis are of independent interest, and have applications in decentralized computing under constraints, logical neural networks, games, robotics, recommender systems, and the like.

Exemplary Contributions

By leveraging the min-max saddle-point formulation, a safe decentralized policy gradient (PG) descent and ascent algorithm is created, i.e., Safe Dec-PG, which is able to deal with a class of multi-agent safe RL problems over a graph. Pertinently, theoretical results are provided that quantify the convergence rate of Safe Dec-PG to an ϵ-first-order stationary points (FOSP) of the considered non-convex min-max problem in the order of

$$\frac{1}{{ϵ}^{4}}$$

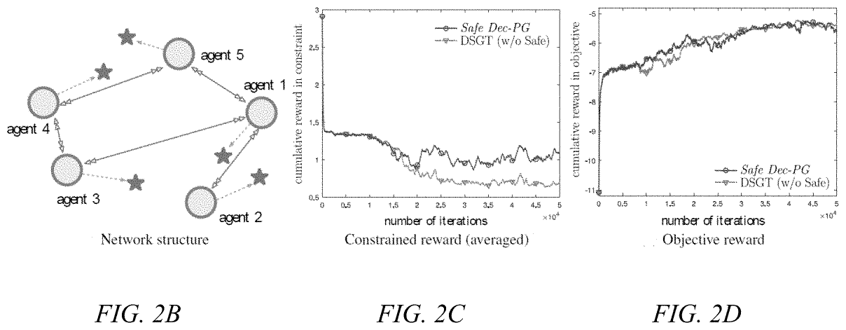

(or equivalently the optimality gap is shrinking in the order of

$$\frac{1}{\sqrt{N}}$$

where N denotes the total number of iterations). When the graph is fully connected, in the sense that there is no consensus error (each agent can know all the other agents' policy(ies) at each iteration), Safe Dec-PG will reduce to a centralized algorithm. Advantageously, even in the case of a centralized algorithm, the obtained convergence rate is still comparable to the state-of-the-art result. FIG. 2A is a table illustrating a detailed comparison between Safe Dec-PG and existing stochastic non-convex concave min-max algorithms in the centralized setting, in accordance with an example embodiment.

Exemplary advantages of Safe Dec-PG are highlighted as follows:

simplicity: the structure of implementing the algorithm is single-loop, where the parameters that need to be tuned are only the step sizes in the minimization and maximization subproblems;

theoretical guarantees: it is theoretically provable that Safe Dec-PG is able to find an ϵ-FOSP of the formulated non-convex min-max problem within

$$( \frac{1}{{ϵ}^{4}} )$$

number of iterations, matching the standard convergence rate of centralized stochastic gradient descent (SGD) and decentralized SGD to ϵ-FOSPs in non-convex scenarios; and

applicability: Safe Dec-PG is a general optimization problem solver, which can be applied for dealing with many non-convex min-max problems, and can be implemented in either a decentralized way over a network or on a single machine.

Multiple numerical results showcase the superiority of the algorithms applied in the problems of safe decentralized RL compared with the classic decentralized methods without safety considerations.

Safe MARL with Decentralized Agents

Multi-Agent Constrained Markov Decision Process (M-CMDP)

Consider a team of n agents operating in a common environment, denoted by [symbol] =[n]. No central controller exists to either make the decisions or collect any information for the agents. Agents are instead allowed to communicate with each other over a communication network [symbol] =( [symbol] ,ε), with ε being the set of communication links that connect the agents. Such a decentralized model with networked agents finds broad applications in distributed cooperative control problems, and has been advocated as one of the most popular paradigms in decentralized MARL. More importantly, each agent has some safety constraints, in the form of bounds on some long term cost, that involve the joint policy(ies) of all agents. The following model of networked multi-agent constrained Markov decision process (M-CMDP) is introduced to characterize this setting.

Definition 1 (Networked Multi-Agent CMDP (M-CMDP))

A networked multi-agent CMDP is described by a tuple ( [symbol] ,{ [symbol] ᵢ} [symbol] ,P,{Rᵢ [symbol] , [symbol] ,{Cᵢ [symbol] ,γ) where [symbol] is the state space shared by all the agents, [symbol] ᵢ is the action space of agent I, and [symbol] is a communication network (a well-connected graph). Let [symbol] =Πᵢ₋₁ⁿ [symbol] ᵢ the joint action space of all agents; then, Rᵢ: [symbol] × [symbol] → [symbol] and Cᵢ: [symbol] × [symbol] → [symbol] are the local rewards and cost functions of agent i, and P: [symbol] × [symbol] × [symbol] →[0, 1] is the state transition probability of the Markov decision process (MDP). γ∈(0, 1) denotes the discount factor. The states [symbol] and actions [symbol] are globally observable, while the rewards and costs are observed locally/privately at each agent.

The networked M-CMDP proceeds as follows. At time t, each agent i chooses its own action [symbol] ᵢ^{t} given [symbol] ^{t}, according to its local policy πᵢ: S→Δ( [symbol] ᵢ), which is usually parameterized as π_{w}_{ᵢ} by some parameter wᵢ∈Θᵢ (where the parameter is, for example, a learned weight) with dimension dᵢ. The networked agents try to learn a joint policy π_{w}_{ᵢ}: [symbol] →Δ( [symbol] ) given by π_{θ}( [symbol] , [symbol] )= [symbol] π_{w}_{ᵢ}( [symbol] , [symbol] ᵢ) with θ=[w₁^{T} . . . wₙ^{T}]^{T}∈ [symbol] ^{d}, where d∈Σᵢ₌₁ⁿdᵢ denotes the whole problem dimension. As a team, the objective of all agents is to collaboratively maximize the globally average return over the network (equivalent to minimizing the opposite of it), dictated by R̅( [symbol] , [symbol] )=n⁻¹· [symbol] Rᵢ( [symbol] , [symbol] ), with only its local observations of the rewards, subject to some safety constraints dictated by Cᵢ( [symbol] , [symbol] ). At each node, there can be multiple safety constraints. These rewards describe different objectives that the agent is required to achieve, such as remaining within a region of the state space, or not running out of memory/battery. Here, assume that each agent is associated with m cost functions, so Cᵢ( [symbol] , [symbol] ) is a mapping of [symbol] × [symbol] to [symbol] ^{m}. Specifically, the team aims to find the joint policy π_{θ} that

$${min}_{θ ∈ Θ} {J}_{0}^{R} ( θ ) {=}^{Δ} 𝔼 ( - \frac{1}{n} {\sum }_{t \geq 0} {γ}^{t} {\sum }_{i ∈ N} {R}_{i} ( {t}^{} , {a}^{t} ) \vert {0}^{} {π}_{θ} ) \qquad ( 1 a )$$

$$s . t . {J}_{i}^{C} ( θ ) {=}^{Δ} 𝔼 ( {\sum }_{t \geq 0} {γ}^{t} {C}_{i} ( {t}^{} , {t}^{} ) \vert {0}^{} {π}_{θ} ) \geq {c}_{i} , {∀}_{i} ∈ N \qquad ( 1 b )$$

where Θ=Πᵢ₌₁^{N}Θᵢ is the joint policy parameter space, J₀^{R}(θ) corresponds to the negative team-average discounted long-term return, Jᵢ^{C}(θ): [symbol] ^{d}→ [symbol] ^{m} denotes the long-term costs of agent i, cᵢ∈ [symbol] ^{m}, ∀ᵢ are the lower-bounds of Jᵢ^{C}(θ), ∀ᵢ that impose the safety constraints, and [symbol] is taken over all randomness including the policy and the underlying Markov chain. Each agent i only has access to its own reward and cost Rᵢ and Cᵢ, and the desired bound cᵢ. Note that the results can be straightforwardly generalized to the setting where each agent has a different number of costs, at the expense of unnecessarily complicated notations. In general, the long-term return J₀^{R}(θ) is non-convex with respect to the policy parameter θ, as with the constraint functions Jᵢ^{C}(θ), ∀ᵢ, which makes the problem challenging to solve using first-order PG methods.

Primal-Dual for Safe M-CMDP

Viewing the team as a single agent, the problem above falls into the regime of the standard constrained Markov decision process (MD-P), which has been widely studied in single-agent safe RL. Nonetheless, in a decentralized paradigm, standard RL algorithms for solving a constrained Markov decision process (CMD-P) are not applicable, as they require the instantaneous access to the team-average reward and all cost functions {Cᵢ [symbol] . Instead, the problem is reformulated as a de-centralized non-convex optimization problem with non-convex constraints, in order to develop decentralized policy optimization algorithms. In particular, letting Jᵢ^{R}(θ) [symbol] [symbol] (−Σ_{t≥0}γ^{t}Rᵢ( [symbol] ^{t}, [symbol] ^{t})| [symbol] ⁰,π_{θ}), the networked multi-agent CMDP is:

$${min}_{\{ {θ}_{i} ∈ Θ \}} \frac{1}{n} {\sum }_{i ∈ N} {J}_{i}^{R} ( {θ}_{i} ) \qquad ( 2 )$$

$$s . t . {θ}_{i} = {θ}_{j} j ∈ {N}_{i} , {c}_{i} - {J}_{i}^{C} ( {θ}_{i} ) \leq 0 , {∀}_{i} ∈ N ,$$

where [symbol] ⊆ [symbol] denotes the set of the neighboring agents of agent i over the network, and θᵢ is the local copy of the policy parameter θ (i.e., the concatenation of all the agents' parameters). By the Lagrangian method, the problem (2) can be written as:

$${min}_{\{ {θ}_{i} ∈ Θ \}} {min}_{\{ λ \geq 0 \}} ℒ ( {θ}_{1} , … , {θ}_{n} , {λ}_{1} , … , {λ}_{n} ) \qquad ( 3 a )$$

$$s . t . {θ}_{i} = {θ}_{j} j ∈ {N}_{i} , {∀}_{i} \qquad ( 3 b )$$

$$where$$

$$ℒ ( {θ}_{1} , … , {θ}_{n} , {λ}_{1} , … , {λ}_{n} ) {=}^{Δ} \frac{1}{n} {\sum }_{i ∈ N} {J}_{i}^{R} ( {θ}_{i} ) + 〈 {g}_{i} ( {θ}_{i} ) , {λ}_{i} 〉 \qquad ( 4 )$$

gᵢ(θᵢ) [symbol] cᵢ−Jᵢ^{C}(θᵢ), and λ₁, . . . , λₙ denote the dual variables.

Potentially Pertinent Issues in Solving Safe Decentralized RL

To this end, the multi-agent safe RL problem has been formulated as (3). Unfortunately, there is no existing work that is able to solve this problem to its FOSPs with any theoretical guarantees. Pertinent difficulties here include:
there are two types of constraints in this problem: one is the consensus equality constraint and the other one is the long term cumulative reward related inequality constraint;

the constraints and loss functions are both in an expected discounted cumulative reward form and possibly non-convex, while most of the classical non-convex algorithms, e.g., neural nets training, are designed for the case where only the loss functions are non-convex;

the problem is stochastic in nature and the PG estimate is biased instead of unbiased, due to the finite-horizon approximation, so extra efforts are needed to quantify how biased estimates affect the convergence results; and

from a min-max saddle-point perspective, the minimization problem is non-convex and the maximization problem is concave (linear), while there is also a consensus error coupled with both minimization and maximization optimization variables (disentangling this error from the minimization and maximization processes will result in a significant different theorem proving technique compared with the existing theoretical works).

Therefore, solving this family of stochastic non-convex problems over a graph is much more challenging than solving the classical problems, e.g., centralized min-max saddle-point problems, decentralized consensus problems, stochastic non-convex problems, and so on. In one example embodiment, a new gradient tracking based single loop primal dual algorithm is introduced to deal with this M-CMDP problem.

Safe M-CMDP Algorithm

The safe policy gradient used in Safe Dec-PG is introduced as the following.

Safe Policy Gradient

The search for an optimal policy can thus be performed by applying the gradient descent-type iterative methods to the parametrized optimization problem (3). The gradient of each agent's cumulative loss Jᵢ^{R}(θᵢ) in (3) can be written as:

$${∇}_{{θ}_{i}} {J}_{i}^{R} ( {θ}_{i} ) = 𝔼 [ {\sum }_{t = 0}^{∞} ( {\sum }_{τ = 0}^{t} ∇ log {π}_{{θ}_{i}} ( {τ}^{} \vert {τ}^{} ; {θ}_{i} ) ) {γ}^{t} {R}_{i} ( {t}^{} , {t}^{} ) ]$$

where ( [symbol] ^{t}, [symbol] ^{t}) are obtained from each trajectory under the joint policy (parametrized by θᵢ, ∀ᵢ). When the MDP model is unknown, the stochastic estimate of PG is often used, that is

$${\hat{∇}}_{{θ}_{i}} {J}_{i}^{R} ( {θ}_{i} ) = {\sum }_{t = 0}^{∞} ( {\sum }_{τ = 0}^{t} ∇ log {π}_{{θ}_{i}} ( {τ}^{} \vert {τ}^{} ; {θ}_{i} ) ) {γ}^{t} {R}_{i} ( {t}^{} , {t}^{} )$$

which is called the gradient of a partially observable MDP (abbreviated as G(PO)MDP PG). The G(PO)MDP gradient is an unbiased estimator of the PG.

Likewise, the stochastic PG estimate of each agent's Jᵢ^{C}(θᵢ) in (3) can be written as

$${\hat{∇}}_{{θ}_{i}} {J}_{i}^{C} ( {θ}_{i} ) = {\sum }_{t = 0}^{∞} ( {\sum }_{τ = 0}^{t} ∇ log {π}_{{θ}_{i}} ( {τ}^{} \vert {τ}^{} ; {θ}_{i} ) ) {γ}^{t} {C}_{i} ( {t}^{} , {t}^{} )$$

Let fᵢ(θᵢ,λᵢ) [symbol] Jᵢ^{R}(θᵢ)+ [symbol] cᵢ−Jᵢ^{C}(θᵢ),λᵢ [symbol] , ∀ᵢ for notational simplicity. Then, the policy gradients with respect to primal variables are

\hat{∇}_{θ}_{ᵢ}fᵢ(θᵢ,λᵢ)=\hat{∇}_{θ}_{ᵢ}Jᵢ^{R}(θᵢ)+ [symbol] \hat{∇}_{θ}_{ᵢ}Jᵢ^{C}(θᵢ),λᵢ [symbol] ,∀ᵢ (5)

and the policy gradients with respect to dual variables are

\hat{∇}_{λ}_{ᵢ}fᵢ(θᵢ,λᵢ)=cᵢ−Ĵᵢ^{C}(θᵢ),∀ᵢ (6)

where Ĵᵢ^{C}(θᵢ) [symbol] Σₜ₌₀^{∞}γ^{t}Cᵢ( [symbol] ^{t}, [symbol] ^{t}| [symbol] ⁰,π_{θ}_{ᵢ}). Note that the stochastic gradients in (5) and (6) use only one trajectory of the Markov chain, which may incur large variance. Akin to mini-batch in SGD, a natural solution is to average over K trajectories to obtain the policy gradient with respect to the primal variables denoted as \hat{∇}_{θ}_{ᵢ}^{K}fᵢ(θᵢ,λᵢ), ∀ᵢ and with respect to the dual variables denoted as \hat{∇}_{λ}_{ᵢ}fᵢ(θᵢ,λᵢ), ∀ᵢ. In simulations, sampling an infinite trajectory may not be tractable, and a finite-horizon approximation of the PGs (5) and (6) is employed, which are denoted as \hat{∇}_{θ}_{ᵢ}^{T,K}fᵢ(θᵢ,λᵢ) and \hat{∇}_{λ}_{ᵢ}^{T,K}fᵢ(θᵢ,λᵢ). Also, a set of globally observable states and actions denoted by ( [symbol] ₖ^{τ}, [symbol] ₖ^{τ}) may be defined, where k denotes the index of trajectories and τ denotes the index of time. Consequently, the stochastic estimate of PG with K trajectories (samples) and a finite-horizon truncation of length T can be expressed as:

$${\hat{∇}}_{{θ}_{i}}^{T , K} {f}_{i} ( {θ}_{i} , {λ}_{i} ) = {\hat{∇}}_{{θ}_{i}}^{T , K} {J}_{i}^{R} ( {θ}_{i} ) - 〈 {\hat{∇}}_{{θ}_{i}}^{T , K} {J}_{i}^{C} ( {θ}_{i} ) , {λ}_{i} 〉 , \qquad ( 7 a )$$

$${\hat{∇}}_{{λ}_{i}}^{T , K} {f}_{i} ( {θ}_{i} , {λ}_{i} ) = {c}_{i} - {( {\hat{J}}_{i}^{C} )}^{T , K} ( {θ}_{i} ) {=}^{Δ} {\hat{g}}_{i} ( {θ}_{i} ) \qquad ( 7 b )$$

$$Where$$

$${\hat{∇}}_{{θ}_{i}}^{T , K} {J}_{i}^{R} ( {θ}_{i} ) {=}^{Δ} \frac{1}{K} {\sum }_{k = 1}^{K} {\sum }_{t = 0}^{T} ( {\sum }_{τ = 0}^{t} ∇ log {π}_{{θ}_{i}} ( {k}_{τ}^{} \vert {k}_{τ}^{} ; {θ}_{i} ) ) {γ}^{t} {R}_{i} ( {k}_{t}^{} , {k}_{t}^{} ) , \qquad ( 8 )$$

$${\hat{∇}}_{{θ}_{i}}^{T , K} {J}_{i}^{C} ( {θ}_{i} ) {=}^{Δ} \frac{1}{K} {\sum }_{k = 1}^{K} {\sum }_{t = 0}^{T} ( {\sum }_{τ = 0}^{t} ∇ log {π}_{{θ}_{i}} ( {k}_{τ}^{} \vert {k}_{τ}^{} ; {θ}_{i} ) ) {γ}^{t} {C}_{i} ( {k}_{t}^{} , {k}_{t}^{} ) , \qquad ( 9 )$$

and (Ĵᵢ^{C})^{T,K}(θᵢ) [symbol] K⁻¹Σₖ₌₁^{K}Σₜ₌₀^{T}γ^{t}Cᵢ( [symbol] ₖ^{t}, [symbol] ₖ^{t}). Note that the finite length horizontal truncation will make the stochastic estimate PG become biased.

Safe Dec-PG: Safe Decentralized Policy Gradient

After obtaining the PG estimates, the disclosed Safe Dec-PG algorithm is as follows. For notational simplicity, in the following, the problem dimension is assumed to be 1. The parameters of the parametrized policy at each node are first updated by:

θᵢ^{r+1}=Σ_{j∈N}_{ᵢ}Wᵢⱼθⱼ^{r}−β^{r}ϑᵢ^{r}, (10)

where r denotes the index of the iterations, β^{r} is the step size of PG descent, ϑᵢ^{r} is an auxiliary (tracking) variable (which will be introduced with more details later in (11)), and Wᵢⱼ is a weight matrix that characterizes the relations among the nodes over graph g.

Next, detailed descriptions about W and ϑ are provided: 1) the weight matrix is double stochastic (i.e., the graph is well-connected), which is defined as follows: if there exists a link between node i and node j, then Wᵢⱼ>0, otherwise Wᵢⱼ=0, and W satisfies W1=1 and 1^{T}W1=1^{T}. There are many ways of designing the weight matrix based on the connectivity of the graph. Suitable techniques include Metropolis-Hasting weight, maximum-degree weight, Laplacian weight; 2) due to the partial observability of each agent, the variable ϑᵢ^{r} here is proposed to approximate the full PG of the network (i.e., n⁻¹Σᵢ₌₁ⁿ\hat{∇}_{θ}_{ᵢ},fᵢ(θᵢ,λᵢ)), and is updated locally as:

ϑᵢ^{r+1}=Σ_{j∈N}_{ᵢ}Wᵢⱼϑⱼ^{r}+\hat{∇}_{θ}_{ᵢ}^{T,K}fᵢ(θᵢ^{r+1},λᵢ^{r})−\hat{∇}_{θ}_{ᵢ}^{T,K}fᵢ(θᵢ^{r},λᵢ^{r}),∀ᵢ (11)

with ϑᵢ⁰ [symbol] 0, ∀ᵢ. This update rule is similar to the (stochastic) gradient tracking technique proposed for both classical consensus based (deterministic or stochastic) distributed optimization problems. But here, since there are dual variable updates, at each time the evaluated gradient is also dependent on λᵢ^{r}, so it is not clear whether the tracked full PG by ϑᵢ^{r} is still accurate enough so that the resulting sequence can converge to the stationary points of problem (3). In the section on performance analysis below, the conditions that can ensure the convergence of Safe Dec-PG in solving problem (3) are shown.

In the disclosed techniques, instead of performing a vanilla dual update, a (quadratic) perturbation term (a.k.a. smoothing technique) is added to the maximization procedure as follows:

$${λ}_{i}^{r + 1} = arg {max}_{{λ}_{i} \geq 0} 〈 {\hat{∇}}_{{λ}_{i}}^{T , K} {f}_{i} ( {θ}_{i}^{r + 1} , {λ}_{i}^{r} ) , {λ}_{i} - {λ}_{i}^{r} 〉 - \frac{1}{2 ρ} {‖ {λ}_{i} - {λ}_{i}^{r} ‖}^{2} - \frac{{γ}^{r}}{2} {‖ {λ}_{i} ‖}^{2} , {∀}_{i} \qquad ( 12 )$$

where ρ>0 is the stepsize of PG ascent in updating λᵢ^{r}, γ^{r} (to be defined below) is a diminishing parameter. The perturbation term

$$\frac{{γ}^{r}}{2} {‖ {λ}_{i} ‖}^{2}$$

plays a pertinent role in ensuring the convergence of Safe Dec-PG. It adds some (desired) curvature to this subproblem (12) in such a way that it is possible to quantify the maximum ascent of the constructed potential function (a Lyapunov-like function that will be used to measure the progress of the disclosed algorithm) after the update of λᵢ^{r}. Then, this parameter gradually reduces the problem curvature to resemble the original subproblem such that the obtained solution is the FOSP of problem (3) rather than a deviated one. Note that (12) can also be easily implemented locally by:

λᵢ^{r+1}= [symbol] ((1−ργ^{r})λᵢ^{r}+ρ\hat{∇}_{λ}_{ᵢ}^{T,K}fᵢ(θᵢ^{r+1},λᵢ^{r})),∀ᵢ (13)

where [symbol] denotes the projection operator, and Λ={λᵢ|λᵢ≥0}, ∀ᵢ stands for the feasible set.

It can be seen that a significant advantages of Safe Dec-PG in one or more embodiments is its simplicity of updating rules for all the parameters: 1) a single loop algorithm; and 2) each variable only needs to be updated locally through exchanging the parameters over the communication channel. From the following convergence analysis, it is shown that when some mild conditions hold, Safe Dec-PG is guaranteed to find the FOSPs of problem (3) by controlling the step sizes used in the minimization and maximization procedures properly.

FIG. 1C is an example algorithm for the decentralized policy gradient (PG), Safe Dec-PG, in accordance with an example embodiment. Each agent 104 performs a local model update via the model update unit 154, which can be implemented in software by solving equation (10) using computer code written in a high-level language and compiled or interpreted into machine-level code. A rollout (including the derivation of the stochastic estimate of PG with K trajectories (samples) and a finite-horizon truncation of length 7) is performed via the gradient computation unit 158, which can be implemented in software by solving equations (7a) and (7b) using computer code written in a high-level language and compiled or interpreted into machine-level code. Gradient tracking 170 is performed via the collaboration network 166. The updating of the variable Dr′ is performed by the model update unit 154, which can be implemented in software by solving equation (11) using computer code written in a high-level language and compiled or interpreted into machine-level code. The gradient of each agent's cumulative loss, (Ĵᵢ^{C})^{T,K}(θᵢ^{r+1}), is calculated and the dual variable λᵢ^{r+1} is updated by the constraint awareness unit 162, which can be implemented in software by solving equation (13) using computer code written in a high-level language and compiled or interpreted into machine-level code. Note that [symbol] is the gradient of each agent's cumulative loss of the constraints; equation (13) corresponds to the gradient of the constrained loss function.

Performance Analysis of Safe Dec-PG

Assumptions

Assume that fᵢ, gᵢ, ∀ᵢ satisfy a Lipschitz continuous condition. To be more specific:

Assumption 1: Assume functions ∇fᵢ(θᵢ,λᵢ), ∀ᵢ have L-Lipschitz continuity with respect to θᵢ, ∀ᵢ and functions gᵢ(θᵢ)∀ᵢ have L′-Lipschitz continuity with respect to θᵢ, ∀ᵢ.

Next, assume the connectivity of the graph, which specifies the topology of the communication channel, so that the consensus step can be performed in a decentralized way.

Assumption 2: Assume the network is well-connected (a.k.a. strongly-connected), i.e., W is a double stochastic matrix. Also λₘₐₓ(W) [symbol] η<1, where λₘₐₓ(W) denotes the second largest eigenvalue of the weight matrix W.

Assumption 3: It is assumed that the rewards in both objective and constraints are upper bounded by G, i.e., max{Rᵢ( [symbol] ^{t}, [symbol] ^{t}), Cᵢ( [symbol] ^{t}, [symbol] ^{t}),∀ᵢ}≤G, and the true PG is upper bounded by G′, i.e., ∥∇ log π_{θ}_{ᵢ}( [symbol] | [symbol] ;θᵢ)∥≤G′,∀ᵢ,τ).

The first part of Assumption 3 requires the boundedness of the instantaneous reward, which makes sense in practice since the physical systems commonly output finite magnitudes of responses. The second part requires the partial derivatives of the log function of the policies, i.e., ∥∇ log π_{θ}_{ᵢ}( [symbol] | [symbol] ;θᵢ) to be bounded, which can be satisfied by e.g., parametrized Gaussian policies.

Assumption 4: Assume that the Slater condition is satisfied and the size of A is upper bounded by σ_{λ}, i.e., Λ={λᵢ|λᵢ≥0,∥λᵢ∥≤σ_{λ}},∀ᵢ.

Convergence Rate

Since functions Jᵢ^{R} and Jᵢ^{C}, ∀ᵢ are possibly non-convex, finding the global optimal solution for this min-max problem is NP-hard in general. It is of interest to obtain the FOSPs of problem (1). First, the optimality gap is defined as:

$$𝒢 ( \{ {θ}_{i} , {λ}_{i} , {∀}_{i} \} ) = ‖ \frac{1}{n} {\sum }_{i}^{n} ∇ {f}_{i} ( {θ}_{i} , {λ}_{i} ) ‖ \frac{1}{n} {\sum }_{i = 1}^{n} ‖ {λ}_{i} - {𝒫}_{Λ} [ {λ}_{i} + {ℊ}_{i} ( {θ}_{i} ) ] ‖ + \frac{1}{n} {\sum }_{i}^{n} ‖ {θ}_{i} - \overline{θ} ‖ \qquad ( 14 )$$

where the first and second terms of the right hand side of (14) are the standard optimality gap of non-convex min/max problems while the third term is the consensus violation gap that characterizes the difference among the weights over the network, where θ̅ [symbol] n⁻¹Σᵢ₌₁ⁿθᵢ.

Definition 2: If a point (θᵢ*,λᵢ*,∀ᵢ) satisfies ∥ [symbol] ({θᵢ*,λᵢ*,∀ᵢ})∥≤ϵ, then this point is called as an ϵ-approximate first-order stationary points of (3), abbreviated as ϵ-FOSP.

Remark 1: Note that points ({θᵢ*,λᵢ*,∀ᵢ}) satisfying condition [symbol] ({θᵢ*,λᵢ*∀ᵢ})=0 is also known as “quasi-Nash equilibrium” points or “first-order Nash equilibrium” points.

Exemplary convergence results of Safe Dec-PG are given below.

Theorem 1. Suppose Assumptions 1 to 4 hold and the iterates {θᵢ^{r},ϑᵢ^{r},λᵢ^{r},∀ᵢ} are generated by Safe Dec-PG. If the total number of iterations of the algorithm is N and

$$\begin{matrix}T ∼ Ω ( log ( N ) ) , & {γ}^{r} ∼ ( \frac{1}{\sqrt{r}} ) , & {β}^{r} ∼ ( \frac{1}{\sqrt{r}} ) ,\end{matrix} \qquad ( 15 )$$

$$then :$$

$$𝔼 [ {𝒢}^{2} ( \{ {θ}_{i}^{{r}^{′}} , {λ}_{i}^{{r}^{′}} , {∀}_{i} \} ) ] \leq ( \frac{log ( N )}{\sqrt{N}} ) + ( {σ}_{ℊ}^{2} ( T , K ) ) \qquad ( 16 )$$

where constant σ_{g}²(T,K) denotes the variance of PG estimate with respect to function g(⋅), and r′ is picked randomly from 1, . . . , N.

Theorem 1 says that Safe Dec-PG is able to find the solution of (1) at a rate of at least

$$( \frac{log ( N )}{N \frac{1}{2}} )$$

to a neighborhood of the ϵ-FOSP of this problem, where the radius of this ball is determined by the number of trajectories and length of the horizon approximation. The greater the number of trajectories is or the longer the length is, the smaller the radius will be.

Corollary 1: Suppose Assumptions 1 to 4 hold and the iterates {θᵢ^{r},ϑᵢ^{r},λᵢ^{r},∀ᵢ} are generated by Safe Dec-PG. When T, γ^{r}, β^{r} satisfy (15) and K˜ [symbol] (\sqrt{N}):

$$𝔼 [ {𝒢}^{2} ( \{ {θ}_{i}^{{r}^{′}} , {λ}_{i}^{{r}^{′}} , {∀}_{i} \} ) ] \leq ( \frac{log ( N )}{\sqrt{N}} ) \qquad ( 17 )$$

where the total number of iterations of the algorithm is N, and r′ is picked randomly from 1, . . . , N.

Note that one or more embodiments of Safe Dec-PG are not only applicable to constrained MDP problems, but also amenable to solving a wide class of stochastic non-convex concave min-max optimization problems.

When Tis infinitely large, i.e., ϵ_{f}(T)=ϵ_{g}(T)=0, Safe Dec-PG is reduced to a decentralized stochastic non-convex min-max optimization algorithm. In this regime, Safe Dec-PG also provides the state-of-the-art convergence rate to a neighborhood of FOSPs.

When K and T are both infinitely large, i.e., ϵ_{f} (T)=ϵ₉(T)=σ_{f}²(T,K)=σ_{g}²(T,K)=0, Safe Dec-PG is reduced to a deterministic decentralized non-convex min-max algorithm. The convergence rate of Safe Dec-PG is still

$$( \frac{log ( N )}{N \frac{1}{2}} )$$

but with guarantees to the ϵ-FOSPs, matching the convergence rate of Hi-BSA in the centralized case.

Remark 3: The number of nodes, n, does not show up in the numerator of the convergence rate result, indicating that the achievable rate in (17) will not be slowed down by increasing the number of agents and the radius of the neighborhood in (16) will not be magnified as well.

Numerical Experimental Results

Problem setting: to show the performance of safe decentralized RL, the disclosed algorithm was tested on a modern graphical processing unit. FIG. 2B is a graphical representation of a decentralized safe RL system, in accordance with an example embodiment. (The solid line arrows denote the communication graph G, the stars represent the landmarks, and the circles represent the agents.) In the first experiment, n=5 agents were aimed at finding their own landmarks, and all agents were connected by a well-connected graph as shown in FIG. 2B, where every agent can only exchange its parameters θᵢ with its neighbors through the communication channel (denoted by the solid line arrows). Furthermore, each agent has five action options: stay, left, right, up, and down. It is assumed that the states and actions of all the agents are globally observable. The goal of the teamed agents is to find an optimal policy such that the long-term discounted cumulative reward averaged over the network is maximized under a minimum number of collisions with other agents in a long term perspective.

Environment

Different from the existing simulation environment, in one or more embodiments, a new environment is created based on the cooperative navigation task, where the agent and landmark are set as pairs and require that each agent only targets its own corresponding landmark. The rewards considered in the objective function include two parts: i) the first one is based on the distance between the location of the node to its desired landmark, which is a monotonically decreasing function of the distance (i.e., the smaller the distance, the higher the reward will be); and ii) the second one is determined by the minimum distance between two agents. If the distance between two agents is lower than a threshold, it is considered that a collision happens, and both of the agents will be penalized by a large negative reward value, i.e., −1. Finally, the reward at each agent is further scaled by different positive coefficients, representing the heterogeneity, e.g., priority levels, of different agents. The rewards considered in the constraints of (3) are monotonically increasing functions of the minimum distance between two agents, i.e., the closer the two agents are, the lower the reward will be. Here, since only the minimum distance is taken into account at each node, m=1.

Parameters

In one or more embodiments, the policy at each agent is parametrized by a neural network, where there are two hidden layers with 30 neurons in the first layer and 10 neurons in the second. The states of each agent include its position and velocity. Thus, the dimension of the input layer is 20, and the output layer is 5. The discounting factor γ in the cumulative loss was 0.99 in all the tests and, for each episode, the length of the horizon approximation of PG is T=20. Also, K=10 Monte Carlo trials were run independently to compute the approximate PG at each iteration.

FIG. 2C illustrates the long-term cumulative reward of the constraints vs. the number of iterations, in accordance with an example embodiment. FIG. 2D illustrates the long-term cumulative reward of the objective functions vs. the number of iterations, in accordance with an example embodiment. The initial step sizes of Safe Dec-PG and DSGT are both 0.1 and cᵢ=0.8, ∀ᵢ. Here, the results of comparing Safe Dec-PG and DSGT without safety considerations in FIG. 2C and FIG. 2D is shown. From FIG. 2C, it can be observed that the averaged network constrained rewards obtained by Safe Dec-PG are much higher than the ones achieved by DSGT and that Safe Dec-PG converges faster than DSGT as well. From the statistical perspective, this long-term cumulative reward in the constraints could be interpreted as some prior knowledge accounted for in MDP. From FIG. 2D, it can be seen that the rewards in objective function achieved by both Safe Dec and DSGT are similar, implying that the added constraints would not affect the loss of the objective rewards.

In one example embodiment, each agent 104 corresponds to a vehicle in an autonomous vehicle system. Each vehicle is attempting to reach a destination subject to constraints, such as gas capacity, minimizing risk of collision, inter-agent messaging capacity constraints, and the like. The team reward aims to see that each vehicle reach its destination in the shortest amount of time subject to the defined constraints.

In one example embodiment, a cloud computing system is controlled in accordance with the disclosed decentralized policy gradient (PG) technique. Each agent 104 corresponds to a node in the cloud computing system. Each node is attempting to perform computing tasks subject to constraints, such as local computing capacity, inter-node communication capacity, data storage capacity, and the like. The team reward aims to see that all computing tasks are performed in the shortest amount of time subject to the defined constraints.

Given the discussion thus far, it will be appreciated that, in general terms, an exemplary method, according to an aspect of the invention, includes the operations of generating a distributed constrained Markov decision process (D-CMDP) model 154 configured to perform policy optimization using a decentralized policy gradient (PG) method; maximizing a team-average long-term return in performing one or more joint actions, subject to one or more safety constraints, based on an individual reward function 154, 162, 170; and participating in operating a physical system 50 based on the D-CMDP model.

In one aspect, a reinforcement learning system 150 includes a plurality of agents 104, each agent 104 having an individual reward function and one or more safety constraints that involve joint actions of the agents 104, wherein each agent 104 maximizes a team-average long-term return in performing the joint actions, subject to the safety constraints 154, 162, 170, and participates in operating a physical system 50; a peer-to-peer communication network 166 configured to connect the plurality of agents 104; and a distributed constrained Markov decision process (D-CMDP) model 154 implemented over the peer-to-peer communication network 166 and configured to perform policy optimization using a decentralized policy gradient (PG) method, wherein the participation of each agent 104 in operating the physical system 50 is based on the D-CMDP model.

In one example embodiment, the individual reward function and the safety constraints are known to the corresponding agent 104 and unknown to the remaining agents 104.

In one example embodiment, each agent 104 is configured to explore interactions with an environment 108 to maximize a cumulative reward through a reinforcement learning process 150.

In one example embodiment, the safety constraints are in a form of bounds on a long term cost associated with a joint policy of the agents 104.

In one example embodiment, each agent 104 is described by a tuple ( [symbol] ,{ [symbol] ᵢ [symbol] ,P,{Rᵢ [symbol] , [symbol] ,{Cᵢ [symbol] ,γ) where [symbol] comprises a state space shared by the agents 104, a graph [symbol] represents the peer-to-peer communication network 166, [symbol] =Πᵢ₌₁ⁿ [symbol] ᵢ comprises a joint action space of the agents 104, Rᵢ: [symbol] × [symbol] → [symbol] and Cᵢ: [symbol] × [symbol] [symbol] comprise local rewards and cost functions of corresponding agent i, P: [symbol] × [symbol] × [symbol] →[0,1] comprises a state transition probability of the Markov decision process, and γ∈(0, 1) denotes a discount factor.

In one example embodiment, an objective of the agents 104 is to collaboratively maximize a globally average return over the peer-to-peer communication network 166, dictated by R̅( [symbol] , [symbol] )=n⁻¹. [symbol] Rᵢ( [symbol] , [symbol] ), with only local observations of the local rewards, subject to the corresponding safety constraints dictated by Cᵢ( [symbol] , [symbol] ), and wherein each agent 104 is associated with m of the cost functions and Cᵢ( [symbol] , [symbol] ) comprises a mapping [symbol] × [symbol] to [symbol] ^{m}.

In one example embodiment, the local rewards describe different objectives that the corresponding agent 104 is to achieve.

In one example embodiment, at time t, each agent i selects an action [symbol] ᵢ^{t} given a state [symbol] ^{t} according to a corresponding local policy, πᵢ: [symbol] →Δ( [symbol] ᵢ), which is parametrized as π_{w}_{ᵢ} by a parameter wᵢ∈Θᵢ with dimension dᵢ; and each agent 104 learns a joint policy π_{w}_{ᵢ}: [symbol] →Δ( [symbol] ) given by π_{θ}( [symbol] , [symbol] )= [symbol] π_{w}_{ᵢ}( [symbol] , [symbol] ᵢ) with θ=[wᵢ^{T} . . . wₙ^{T}]^{T}∈ [symbol] ^{d}, and where d∈Σᵢ₌₁ⁿdᵢ denotes a whole problem dimension.

In one example embodiment, the joint policy π_{θ} is:

$${min}_{θ ∈ Θ} {J}_{0}^{R} ( θ ) {=}^{Δ} 𝔼 ( - \frac{1}{n} {\sum }_{t \geq 0} {γ}^{t} {\sum }_{i ∈ N} {R}_{i} ( {t}^{} , {t}^{} ) \vert {0}^{} {π}_{θ} )$$

$$s . t . {J}_{i}^{C} ( θ ) {=}^{Δ} 𝔼 ( {\sum }_{t \geq 0} {γ}^{t} {C}_{i} ( {t}^{} , {t}^{} ) \vert {0}^{} {π}_{θ} ) \geq {c}_{i} , {∀}_{i} ∈ N$$

where Θ=Πᵢ₌₁ⁿΘᵢ comprises a joint policy parameter space, Jᵢ^{C}(θ): [symbol] ^{d}→ [symbol] ^{m} denotes long-term costs of a corresponding agent i, cᵢ∈ [symbol] ^{m}, ∀ᵢ comprise lower-bounds of Jᵢ^{C}(θ), ∀ᵢ that impose the safety constraints, and [symbol] is taken over all randomness including an initial policy, an initial state, and an underlying Markov chain. In one example embodiment, a stochastic PG estimate of each agent's Jᵢ^{C}(θᵢ) in min_{{θ}_{ᵢ}_{∈Θ}}min_{{λ≥0}} [symbol] (θ₁, . . . , θₙλ₁, . . . , λₙ)

$$s . t . {θ}_{i} = {θ}_{j} j ∈ {N}_{i} , {∀}_{i}$$

$$is :$$

$${\hat{∇}}_{{θ}_{i}} {J}_{i}^{C} ( {θ}_{i} ) = {\sum }_{t = 0}^{∞} ( {\sum }_{τ = 0}^{t} ∇ log {π}_{{θ}_{i}} ( {τ}^{} \vert {τ}^{} ; {θ}_{i} ) ) {γ}^{t} {C}_{i} ( {t}^{} , {t}^{} )$$

wherein:

policy gradients with respect to primal variables are:

\hat{∇}_{θ}_{ᵢ}(θᵢ,λᵢ)=\hat{∇}_{θ}_{ᵢ}Jᵢ^{R}(θᵢ)+ [symbol] \hat{∇}_{θ}_{ᵢ}Jᵢ^{C}(θᵢ),λᵢ [symbol] ,∀ᵢ

and the policy gradients with respect to dual variables are:

∇_{λ}_{ᵢ}fᵢ(θᵢ,λᵢ)=cᵢ−Ĵᵢ^{C}(θᵢ),∀ᵢ

where Jᵢ^{C}(θᵢ) [symbol] Σₜ₌₀^{∞}γ^{t}Cᵢ( [symbol] ^{t}, [symbol] ^{t}| [symbol] ⁰,π_{θ}_{ᵢ}).

In one example embodiment, parameters of the individual reward function for each agent 104 are updated by:

θᵢ^{r+1}=Σ_{j∈N}_{ᵢ}Wᵢⱼθᵢ^{r}−β^{r}ϑᵢ^{r},

where r denotes an index of iterations, β^{r} comprises a step size of PG descent, Dr comprises an auxiliary tracking variable, and Wᵢⱼ comprises a weight matrix that characterizes relations among the agents over graph [symbol] .

In one example embodiment, the variable ϑ₁^{r} is updated locally as:

θᵢ^{r+1}=Σ_{j∈N}_{ᵢ}Wᵢⱼϑᵢ^{r}+\hat{∇}_{θ}_{ᵢ}^{T,K}fᵢ(θᵢ^{r+1},λᵢ^{r})−\hat{∇}_{θ}_{ᵢ}^{T,K}fᵢ(θᵢ^{r},λᵢ^{r}),∀ᵢ

with ϑᵢ⁰ [symbol] 0, ∀ᵢ.

In one example embodiment, the update is based on:

$${λ}_{i}^{r + 1} = arg {max}_{{λ}_{i}} 〈 {\hat{∇}}_{{θ}_{i}}^{T , K} {f}_{i} ( {θ}_{i}^{r + 1} , {λ}_{i}^{r} ) , {λ}_{i} - {λ}_{i}^{r} 〉 - \frac{1}{2 ρ} {‖ {λ}_{i} - {λ}_{i}^{r} ‖}^{2} - \frac{{γ}^{r}}{2} {‖ {λ}_{i} ‖}^{2} , {∀}_{i}$$

where ρ>0 comprises a step size of policy gradient (PG) ascent in updating λᵢ^{r}, and γ^{r} comprises a diminishing parameter.

In one example embodiment, rewards considered in an individual reward function of the agents 104 are based on a distance between a location of an agent 104 and its desired landmark and a minimum distance between two agents 104 of the plurality of agents 104.

In one example embodiment, two of the plurality of agents 104 are penalized by a negative reward value in response to a distance between the two agents 104 being lower than a defined threshold.

In one example embodiment, a reward at one of the two agents 104 is scaled by positive coefficients representing a heterogeneity of different agents 104.

In one example embodiment, a plurality of computing nodes 10 are configured as a cloud computing environment 50, wherein each agent 104 resides on one of the computing nodes 10 and each computing node 10 operates in accordance with the corresponding distributed constrained Markov decision process (D-CMDP) model.

In one example embodiment, each agent 104 is configured to participate in operating a vehicle 54N in accordance with the corresponding distributed constrained Markov decision process (D-CMDP) model.

In one aspect, a computer program product for federated learning comprises a computer readable storage medium having program instructions embodied therewith, the program instructions executable by a computer to cause the computer to perform a method comprising generating a distributed constrained Markov decision process (D-CMDP) model 154 configured to perform policy optimization using a decentralized policy gradient (PG) method; maximizing a team-average long-term return in performing one or more joint actions, subject to one or more safety constraints, based on an individual reward function 154, 162, 170; and participating in operating a physical system 50 based on the D-CMDP model.

Advantageously, one or more embodiments are able to solve multi-agent CMDP problems, where the cumulative rewards in both loss function and constraints are included. By leveraging the primal-dual optimization framework, one or more embodiments of Safe Dec-PG maximize the averaged network long-term cumulative rewards and take into account the safety-related constraints as well. Theoretically, the first convergence rate guarantees of the decentralized stochastic gradient descent ascent method are provided to an ϵ-FOSP of a class of non-convex min-max problems at a rate of O(1/ϵ4). Numerical results show that the obtained constraint rewards by Safe Dec-PG are indeed much higher than the case where the safety consideration is not incorporated without loss of both convergence rate and final objective rewards.

It is to be understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

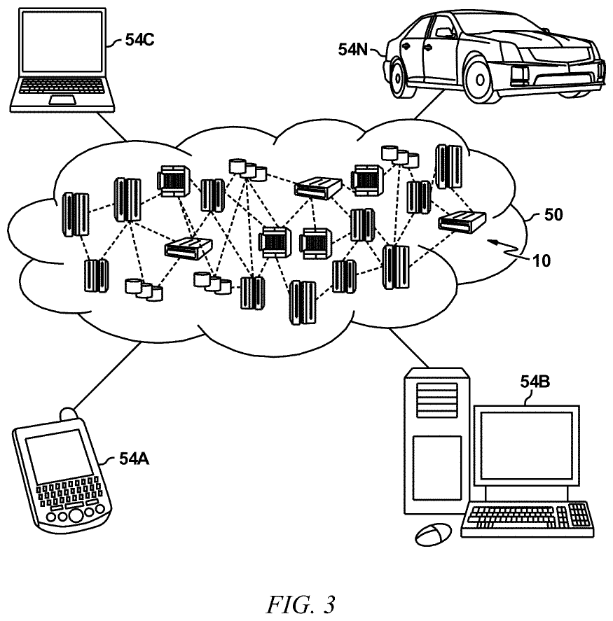

Referring now to FIG. 3, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 3 are intended to be illustrative only and that computing nodes 10 and cloud computing environment 50 can communicate with any type of computerized device over any type of network and/or network addressable connection (e.g., using a web browser).

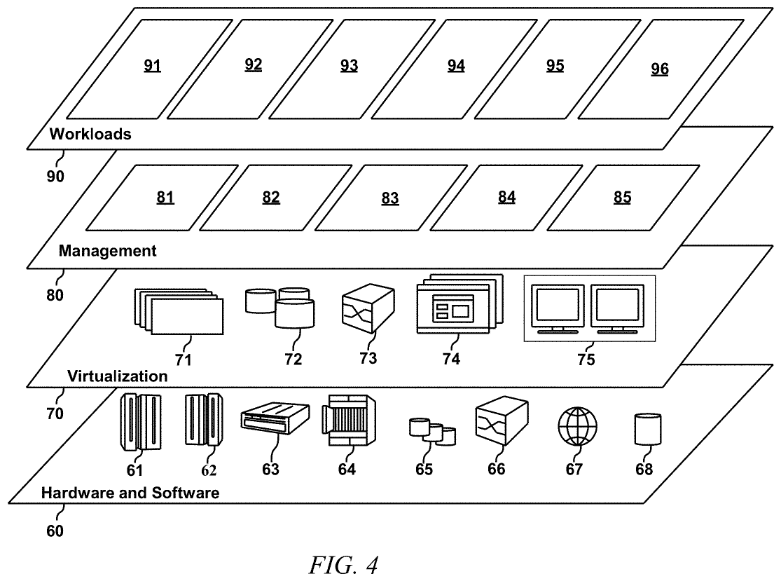

Referring now to FIG. 4, a set of functional abstraction layers provided by cloud computing environment 50 (FIG. 3) is shown. It should be understood in advance that the components, layers, and functions shown in FIG. 4 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA.

Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and an RL component 96 that implements aspects of multi-agent RL.

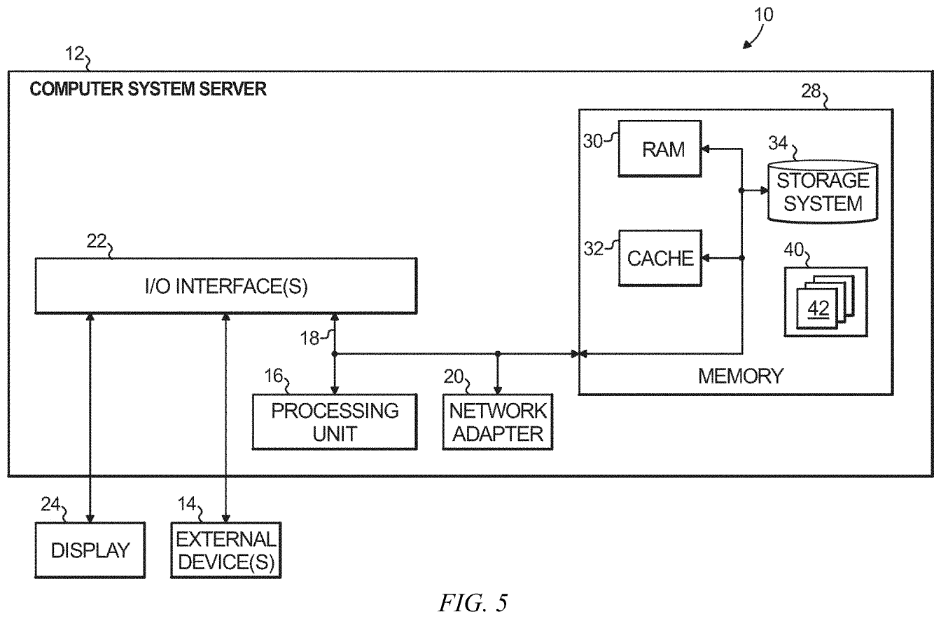

One or more embodiments of the invention, or elements thereof, can be implemented in the form of an apparatus including a memory and at least one processor that is coupled to the memory and operative to perform exemplary method steps. FIG. 5 depicts a computer system that may be useful in implementing one or more aspects and/or elements of the invention, also representative of a cloud computing node according to an embodiment of the present invention. Referring now to FIG. 5, cloud computing node 10 is only one example of a suitable cloud computing node and is not intended to suggest any limitation as to the scope of use or functionality of embodiments of the invention described herein. Regardless, cloud computing node 10 is capable of being implemented and/or performing any of the functionality set forth hereinabove.

In cloud computing node 10 there is a computer system/server 12, which is operational with numerous other general purpose or special purpose computing system environments or configurations. Examples of well-known computing systems, environments, and/or configurations that may be suitable for use with computer system/server 12 include, but are not limited to, personal computer systems, server computer systems, thin clients, thick clients, handheld or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12 may be described in the general context of computer system executable instructions, such as program modules, being executed by a computer system. Generally, program modules may include routines, programs, objects, components, logic, data structures, and so on that perform particular tasks or implement particular abstract data types. Computer system/server 12 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12 in cloud computing node 10 is shown in the form of a general-purpose computing device. The components of computer system/server 12 may include, but are not limited to, one or more processors or processing units 16, a system memory 28, and a bus 18 that couples various system components including system memory 28 to processor 16.

Bus 18 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computer system/server 12 typically includes a variety of computer system readable media. Such media may be any available media that is accessible by computer system/server 12, and it includes both volatile and non-volatile media, removable and non-removable media.

System memory 28 can include computer system readable media in the form of volatile memory, such as random access memory (RAM) 30 and/or cache memory 32. Computer system/server 12 may further include other removable/non-removable, volatile/non-volatile computer system storage media. By way of example only, storage system 34 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18 by one or more data media interfaces. As will be further depicted and described below, memory 28 may include at least one program product having a set (e.g., at least one) of program modules that are configured to carry out the functions of embodiments of the invention.

Program/utility 40, having a set (at least one) of program modules 42, may be stored in memory 28 by way of example, and not limitation, as well as an operating system, one or more application programs, other program modules, and program data. Each of the operating system, one or more application programs, other program modules, and program data or some combination thereof, may include an implementation of a networking environment. Program modules 42 generally carry out the functions and/or methodologies of embodiments of the invention as described herein.

Computer system/server 12 may also communicate with one or more external devices 14 such as a keyboard, a pointing device, a display 24, etc.; one or more devices that enable a user to interact with computer system/server 12; and/or any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted, network adapter 20 communicates with the other components of computer system/server 12 via bus 18. It should be understood that although not shown, other hardware and/or software components could be used in conjunction with computer system/server 12. Examples, include, but are not limited to: microcode, device drivers, redundant processing units, and external disk drive arrays, RAID systems, tape drives, and data archival storage systems, etc.

Thus, one or more embodiments can make use of software running on a general purpose computer or workstation. With reference to FIG. 5, such an implementation might employ, for example, a processor 16, a memory 28, and an input/output interface 22 to a display 24 and external device(s) 14 such as a keyboard, a pointing device, or the like. The term “processor” as used herein is intended to include any processing device, such as, for example, one that includes a CPU (central processing unit) and/or other forms of processing circuitry. Further, the term “processor” may refer to more than one individual processor. The term “memory” is intended to include memory associated with a processor or CPU, such as, for example, RAM (random access memory) 30, ROM (read only memory), a fixed memory device (for example, hard drive 34), a removable memory device (for example, diskette), a flash memory and the like. In addition, the phrase “input/output interface” as used herein, is intended to contemplate an interface to, for example, one or more mechanisms for inputting data to the processing unit (for example, mouse), and one or more mechanisms for providing results associated with the processing unit (for example, printer). The processor 16, memory 28, and input/output interface 22 can be interconnected, for example, via bus 18 as part of a data processing unit 12. Suitable interconnections, for example via bus 18, can also be provided to a network interface 20, such as a network card, which can be provided to interface with a computer network, and to a media interface, such as a diskette or CD-ROM drive, which can be provided to interface with suitable media.

Accordingly, computer software including instructions or code for performing the methodologies of the invention, as described herein, may be stored in one or more of the associated memory devices (for example, ROM, fixed or removable memory) and, when ready to be utilized, loaded in part or in whole (for example, into RAM) and implemented by a CPU. Such software could include, but is not limited to, firmware, resident software, microcode, and the like.

A data processing system suitable for storing and/or executing program code will include at least one processor 16 coupled directly or indirectly to memory elements 28 through a system bus 18. The memory elements can include local memory employed during actual implementation of the program code, bulk storage, and cache memories 32 which provide temporary storage of at least some program code in order to reduce the number of times code must be retrieved from bulk storage during implementation.

Input/output or I/O devices (including but not limited to keyboards, displays, pointing devices, and the like) can be coupled to the system either directly or through intervening I/O controllers.

Network adapters 20 may also be coupled to the system to enable the data processing system to become coupled to other data processing systems or remote printers or storage devices through intervening private or public networks. Modems, cable modem and Ethernet cards are just a few of the currently available types of network adapters.

As used herein, including the claims, a “server” includes a physical data processing system (for example, system 12 as shown in FIG. 5) running a server program. It will be understood that such a physical server may or may not include a display and keyboard.

One or more embodiments can be at least partially implemented in the context of a cloud or virtual machine environment, although this is exemplary and non-limiting. Reference is made back to FIGS. 3-4 and accompanying text.

It should be noted that any of the methods described herein can include an additional step of providing a system comprising distinct software modules embodied on a computer readable storage medium; the modules can include, for example, any or all of the appropriate elements depicted in the block diagrams and/or described herein; by way of example and not limitation, any one, some or all of the modules/blocks and or sub-modules/sub-blocks described. The method steps can then be carried out using the distinct software modules and/or sub-modules of the system, as described above, executing on one or more hardware processors such as 16. Further, a computer program product can include a computer-readable storage medium with code adapted to be implemented to carry out one or more method steps described herein, including the provision of the system with the distinct software modules.

One example of user interface that could be employed in some cases is hypertext markup language (HTML) code served out by a server or the like, to a browser of a computing device of a user. The HTML is parsed by the browser on the user's computing device to create a graphical user interface (GUI).

Exemplary System and Article of Manufacture Details

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A reinforcement learning system, comprising:
a plurality of agents, each agent having an individual reward function and one or more safety constraints that involve joint actions of the agents, wherein each agent maximizes a team-average long-term return in performing the joint actions, subject to the safety constraints, and participates in operating a physical system.
a peer-to-peer communication network configured to connect the plurality of agents; and
a distributed constrained Markov decision process (D-CMDP) model implemented over the peer-to-peer communication network and configured to perform policy optimization using a decentralized policy gradient (PG) method, wherein the participation of each agent in operating the physical system is based on the D-CMDP model.

2. The system of claim 1, wherein the individual reward function and the safety constraints are known to the corresponding agent and unknown to the remaining agents.

3. The system of claim 1, wherein each agent is configured to explore interactions with an environment to maximize a cumulative reward through a reinforcement learning process.

4. The system of claim 1, wherein the safety constraints are in a form of bounds on a long term cost associated with a joint policy of the agents.

5. The system of claim 1, wherein each agent is described by a tuple ( [symbol] ,{ [symbol] ᵢ [symbol] ,P,{Rᵢ [symbol] , [symbol] ,{Cᵢ [symbol] ,γ) where [symbol] comprises a state space shared by the agents, a graph g represents the peer-to-peer communication network, [symbol] =Πᵢ₌₁ⁿ [symbol] ᵢ comprises a joint action space of the agents, Rᵢ: [symbol] × [symbol] → [symbol] and Cᵢ: [symbol] × [symbol] → [symbol] comprise local rewards and cost functions of corresponding agent i, P: [symbol] × [symbol] × [symbol] →[0, 1] comprises a state transition probability of the Markov decision process, and γ∈(0, 1) denotes a discount factor.

6. The system of claim 5, wherein an objective of the agents is to collaboratively maximize a globally average return over the peer-to-peer communication network, dictated by R̅( [symbol] , [symbol] )=n⁻¹· [symbol] Rᵢ( [symbol] , [symbol] ), with only local observations of the local rewards, subject to the corresponding safety constraints dictated by Cᵢ( [symbol] , [symbol] ), and wherein each agent is associated with m of the cost functions and Cᵢ( [symbol] , [symbol] ) comprises a mapping [symbol] × [symbol] to [symbol] ^{m}.

7. The system of claim 5, wherein the local rewards describe different objectives that the corresponding agent is to achieve.

8. The system of claim 5, wherein, at time t, each agent i selects an action [symbol] ᵢ^{t} given a state [symbol] ^{t} according to a corresponding local policy, πᵢ: [symbol] →Δ( [symbol] ᵢ), which is parametrized as π_{w}_{ᵢ} by a parameter wᵢ∈Θᵢ with dimension dᵢ; and
each agent learns a joint policy π_{w}_{ᵢ}: [symbol] →Δ( [symbol] ) given by π_{θ}( [symbol] , [symbol] )= [symbol] π_{w}_{ᵢ}( [symbol] , [symbol] ᵢ) with θ=[w₁^{T} . . . wₙ^{T}]^{T}∈ [symbol] ^{d}, and where d∈Σᵢ₌₁ⁿdᵢ denotes a whole problem dimension.

9. The system of claim 6, wherein the joint policy π_{θ} is:
$${min}_{θ ∈ Θ} {J}_{0}^{R} ( θ ) {=}^{Δ} 𝔼 ( - \frac{1}{n} {\sum }_{t \geq 0} {γ}^{t} {\sum }_{i ∈ N} {R}_{i} ( {t}^{} , {t}^{} ) \vert {0}^{} {π}_{θ} )$$
$$s . t . {J}_{i}^{C} ( θ ) {=}^{Δ} 𝔼 ( {\sum }_{t \geq 0} {γ}^{t} {C}_{i} ( {t}^{} , {t}^{} ) \vert {0}^{} {π}_{θ} ) \geq {c}_{i} , {∀}_{i} ∈ N$$
where Θ=Πᵢ₌₁ⁿΘᵢ comprises a joint policy parameter space, Jᵢ^{C}(θ): [symbol] ^{d}→ [symbol] ^{m} denotes long-term costs of a corresponding agent i, cᵢ∈ [symbol] ^{m}, ∀ᵢ comprise lower-bounds of Jᵢ^{C}(θ), ∀ᵢ that impose the safety constraints, and [symbol] is taken over all randomness including an initial policy, an initial state, and an underlying Markov chain.

10. The system of claim 6, wherein a stochastic PG estimate of each agent's Jᵢ^{C}(θᵢ) in min_{{θ}_{ᵢ}_{∈Θ}}min_{{λ≥0}} [symbol] (θ₁, . . . , θₙλ₁, . . . , λₙ)
$$s . t . {θ}_{i} = {θ}_{j} j ∈ {N}_{i} , {∀}_{i}$$
$$is :$$
$${\hat{∇}}_{{θ}_{i}} {J}_{i}^{C} ( {θ}_{i} ) = {\sum }_{t = 0}^{∞} ( {\sum }_{τ = 0}^{t} ∇ log {π}_{{θ}_{i}} ( {τ}^{} \vert {τ}^{} ; {θ}_{i} ) ) {γ}^{t} {C}_{i} ( {t}^{} , {t}^{} )$$
wherein:
policy gradients with respect to primal variables are:
\hat{∇}_{θ}_{ᵢ}fᵢ(θᵢ,λᵢ)=\hat{∇}_{θ}_{ᵢ}Jᵢ^{R}(θᵢ)+ [symbol] \hat{∇}_{θ}_{ᵢ}Jᵢ^{C}(θᵢ),λᵢ [symbol] ,∀ᵢ
and the policy gradients with respect to dual variables are:
∇_{λ}_{ᵢ}fᵢ(θᵢ,λᵢ)=cᵢ−Ĵᵢ^{C}(θᵢ),∀ᵢ
where Jᵢ^{C}(θᵢ) [symbol] Σₜ₌₀^{∞}γ^{t}Cᵢ( [symbol] ^{t}, [symbol] ^{t}| [symbol] ⁰,π_{θ}_{ᵢ}).

11. The system of claim 1, wherein parameters of the individual reward function for each agent are updated by:
θᵢ^{r+1}=Σ_{j∈N}_{ᵢ}Wᵢⱼθⱼ^{r}−β^{r}ϑᵢ^{r},
where r denotes an index of iterations, β^{r} comprises a step size of PG descent, ϑᵢ^{r} comprises an auxiliary tracking variable, and Wᵢⱼ comprises a weight matrix that characterizes relations among the agents over graph [symbol] .

12. The system of claim 11, wherein the variable ϑᵢ^{r} is updated locally as:
θᵢ^{r+1}=Σ_{j∈N}_{ᵢ}Wᵢⱼϑⱼ^{r}+\hat{∇}_{θ}_{ᵢ}^{T,K}fᵢ(θᵢ^{r+1},λᵢ^{r})−\hat{∇}_{θ}_{ᵢ}^{T,K}fᵢ(θᵢ^{r},λᵢ^{r}),∀ᵢ
with ϑᵢ⁰ [symbol] 0, ∀ᵢ.

13. The system of claim 12, wherein the update is based on:
$${λ}_{i}^{r + 1} = arg {max}_{{λ}_{i}} 〈 {\hat{∇}}_{{θ}_{i}}^{T , K} {f}_{i} ( {θ}_{i}^{r + 1} , {λ}_{i}^{r} ) , {λ}_{i} - {λ}_{i}^{r} 〉 - \frac{1}{2 ρ} {‖ {λ}_{i} - {λ}_{i}^{r} ‖}^{2} - \frac{{γ}^{r}}{2} {‖ {λ}_{i} ‖}^{2} , {∀}_{i}$$
where ρ>0 comprises a step size of policy gradient (PG) ascent in updating λᵢ^{r} and γ^{r} comprises a diminishing parameter.

14. The system of claim 1, wherein rewards considered in an individual reward function of the agents are based on a distance between a location of an agent and its desired landmark and a minimum distance between two agents of the plurality of agents.

15. The system of claim 1, wherein two of the plurality of agents are penalized by a negative reward value in response to a distance between the two agents being lower than a defined threshold.

16. The system of claim 15, wherein a reward at one of the two agents is scaled by positive coefficients representing a heterogeneity of different agents.

17. The system of claim 1, wherein a plurality of computing nodes are configured as a cloud computing environment, and wherein each agent resides on one of the computing nodes and each computing node operates in accordance with the corresponding distributed constrained Markov decision process (D-CMDP) model.

18. The system of claim 1, wherein each agent is configured to participate in operating a vehicle in accordance with the corresponding distributed constrained Markov decision process (D-CMDP) model.

19. A method comprising:
generating a distributed constrained Markov decision process (D-CMDP) model configured to perform policy optimization using a decentralized policy gradient (PG) method;
maximizing a team-average long-term return in performing one or more joint actions, subject to one or more safety constraints, based on an individual reward function; and
participating in operating a physical system based on the D-CMDP model.

20. A computer program product for federated learning, the computer program product comprising a computer readable storage medium having program instructions embodied therewith, the program instructions executable by a computer to cause the computer to perform a method comprising:
generating a distributed constrained Markov decision process (D-CMDP) model configured to perform policy optimization using a decentralized policy gradient (PG) method;
maximizing a team-average long-term return in performing one or more joint actions, subject to one or more safety constraints, based on an individual reward function; and
participating in operating a physical system based on the D-CMDP model.
